(19) United States
(12) Patent Application Publication
(10) Pub. No.: US 2011/0206093 A1
(43) Pub. Date: Aug. 25, 2011

(54) SIGNAL ACQUISITION METHOD AND SIGNAL ACQUISITION APPARATUS

(75) Inventors: Shunichi Mizuochi, Matsumoto-shi (JP); Yimei Ding, Shiojiri-shi (JP)

(73) Assignee: SEIKO EPSON CORPORATION, Shinjuku-ku (JP)

(21) Appl. No.: 13/032,544

(22) Filed: Feb. 22, 2011

(30) Foreign Application Priority Data
Feb. 23, 2010 (JP) 2010-037168

(51) Int. Cl. H04B 1/707

(52) U.S. Cl. 375/150; 375/E01.002

(57) ABSTRACT

A signal acquisition method includes: performing a correlation operation for a satellite signal received from a positioning satellite; frequency-analyzing a result of the correlation operation over a predetermined time which is equal to or longer than a bit length of navigation message data carried by the satellite signal; extracting a power value in a predetermined frequency which includes at least a specific frequency determined according to the bit length, from a result of the frequency analysis; and acquiring the satellite signal using the extracted power value.

### BACKGROUND

1. Technical Field

The present invention relates to a signal acquisition method and a signal acquisition apparatus.

2. Related Art

A GPS (Global Positioning System) is widely known as a positioning system which uses a positioning signal, and is applied to a position calculation device built into a mobile phone, a car navigation apparatus or the like. In the GPS, a position calculation is performed for calculating position coordinates of the position calculation device and a time piece error on the basis of the information including positions of a plurality of GPS satellites, a pseudo distance from each GPS satellite to the position calculation device, and the like.

A GPS satellite signal transmitted from the GPS satellite is modulated using spread codes called CA (Coarse and Acquisition) codes, which are different according to each GPS satellite. In order to acquire the GPS satellite signal from weak received signals, the position calculation device performs a correlation operation of the received signals and replica CA codes which are replicas of the CA codes, and acquires the GPS satellite signal on the basis of correlation values. In this case, in order to easily detect a peak of the correlation values, a technique is used in which the correlation values obtained by the correlation operation are integrated over a predetermined integration time.

However, since the CA codes themselves which spread modulate the GPS satellite signal are BPSK (Binary Phase Shift Keying) modulated every 20 milliseconds by the navigation message data, polarity of the CA codes may be inverted every 20 milliseconds which is the bit length. Thus, in a case where the correlation values are integrated over the timing when the bit value of the navigation message data is changed, there is a possibility that the correlation values having different signs are integrated. In order to solve this problem, there is known a technique in which correlation values are integrated using assistance data with respect to the timing when the bit value of the navigation message data is changed, as disclosed in JP-A-2001-349935, for example.

According to JP-A-2001-349935, a correlation integration time can be set longer than the bit length (20 milliseconds) of the navigation message data. However, in the technique disclosed in JP-A-2001-349935, it is necessary to acquire the assistance data with respect to the timing when the bit value of the navigation message data is changed, from the outside, thereby causing restrictions or problems related to data acquisition such as a problem of a communication cost or a communication time. In particular, after the navigation message data transmitted from the GPS satellite signal is switched to new data, it is necessary to wait for update of the assistance data and to acquire the new assistance data.

### SUMMARY

An advantage of some aspects of the invention is that it provides a new technique which is capable of performing a correlation process over a correlation integration time longer than the bit length of navigation message data.

According to a first aspect of the invention, there is provided a signal acquisition method including: performing a correlation operation for a received satellite signal, the satellite signal being transmitted from a positioning satellite; frequency-analyzing a result of the correlation operation over a predetermined time which is equal to or longer than a bit length of navigation message data carried by the satellite signal; extracting a power value in a predetermined frequency which includes at least a specific frequency determined according to the bit length, from a result of the frequency analysis; and acquiring the satellite signal using the extracted power value.

According to another aspect of the invention, there may be provided a signal acquisition apparatus including: a correlation operation section which performs a correlation operation for a satellite signal which is transmitted from a positioning satellite and received by a receiving section; an analyzing section which frequency-analyzes a result of the correlation operation over a predetermined time which is equal to or longer than a bit length of navigation message data carried by the satellite signal; an extracting section which extracts a power value in a predetermined frequency which includes at least a specific frequency determined according to the predetermined time, from a result of the frequency analysis; and an acquiring section which acquires the satellite signal using the extracted power value.

According to the above aspects, the correlation operation is performed for the received satellite signal which is transmitted from the positioning satellite. Then, the result of the correlation operation over the predetermined time which is equal to or longer than the bit length of the navigation message data carried by the satellite signal is frequency-analyzed, and the power value in the predetermined frequency which includes at least the specific frequency determined according to the bit length of the navigation message data is extracted from the result of the frequency analysis. Then, the satellite signal is acquired using the extracted power value.

If the correlation operation is performed for the satellite signal by which the navigation message data is carried, time-series data on the correlation values having a sign change is obtained. Thus, if the frequency analysis is performed for the time-series data on the correlation values, the peak of the power value generally appears in the specific frequency determined according to the bit length of the navigation message data. The peak of the specific frequency is generated due to the bit length of the navigation message data, and appears when the correlation process is performed over an arbitrary time which is equal to or longer than the bit length. Thus, it is possible to perform the correlation process over the correlation integration time which is longer than the bit length in which the bit value of the navigation message data can be changed, by using the power value in the specific frequency.

Further, according to a second aspect of the invention, the signal acquisition method according to the first aspect may further include multiplying the result of the correlation operation over the predetermined time by n (n>1), and the frequency analysis may be performed for the result of the correlation operation which is increased by n times.

According to the second aspect, the result of the correlation operation is increased by increasing the result of the correlation operation over the predetermined time by n times. Then, the frequency analysis is performed for the result of the correlation operation which is increased by n times. Accordingly, it is possible to increase a power spectrum density obtained in the frequency analysis.

Further, according to a third aspect of the invention, in the signal acquisition method according to the first or second aspect, the power value may be extracted in the specific frequency and harmonics of the specific frequency, in the extraction.

According to the third aspect, the power value is extracted in the specific frequency and the harmonics of the specific frequency. If the frequency analysis is performed for the correlation operation result, the peak of the power value appears in the frequency of the harmonics of the specific frequency, in addition to the specific frequency. Accordingly, the power value in the specific frequency which is a frequency according to a modulation cycle of the navigation message data and the power value in the harmonics of the specific frequency are used together, thereby making it possible to acquire the satellite signal in a correct and rapid manner.

Further, according to a fourth aspect of the invention, in the signal acquisition method according to any one of the first to third aspects, the acquisition may be performed considering the extracted power value as a power value at a zero frequency, in the satellite signal acquisition.

According to the fourth aspect, the acquisition of the satellite signal is performed considering the extracted power value as the power value at the zero frequency. To consider the extracted power value as the power value at the zero frequency means that the peak of the power value exists in the zero frequency as the result of the frequency analysis. The peak of the power value existing in the zero frequency corresponds to success in detection of the reception frequency of the satellite signal. Accordingly, according to the fourth aspect, it is possible to easily determine success or failure in the signal acquisition.

Further, according to a fifth aspect of the invention, in the signal acquisition method according to any one of the first to fourth aspects, the satellite signal acquisition may include: performing an inverse frequency analysis; and acquiring the satellite signal using a result of the inverse frequency analysis.

Further, the frequency analysis in the first to fifth aspects may use a Fourier transform according to a sixth aspect of the invention, or may use a wavelet transform according to a seventh aspect of the invention.

### BRIEF DESCRIPTION OF THE DRAWINGS

The invention will be described with reference to the accompanying drawings, wherein like numbers reference like elements.

FIG. 1A is an example of a time change in correlation values, FIG. 1B is an example of a frequency analysis result, FIG. 1C is a diagram illustrating power value processing, and FIG. 1D is an example of a time change in reconfigured correlation values.

FIGS. 2A and 2B illustrate direct-current components of correlation values, and FIG. 2C illustrates specific frequency components of correlation values.

FIG. 3 is a block diagram illustrating an example of a functional configuration of a mobile phone.

FIG. 4 is a block diagram illustrating an example of a circuit configuration of a baseband processing circuit section.

FIG. 5 is a flowchart illustrating a work flow of baseband processing.

FIG. 6 is a flowchart illustrating a work flow of a first correlation process.

FIG. 7 is a flowchart illustrating a work flow of a second correlation process.

FIG. 8 is a flowchart illustrating a work flow of a third correlation process.

FIG. 9 is a flowchart illustrating a work flow of a fourth correlation process.

FIG. 10 is a diagram illustrating an example of a result of a correlation process in a phase direction and in a frequency direction in the related art.

FIG. 11 is a diagram illustrating an example of a result of a correlation process in a frequency direction in the related art.

FIG. 12 is a diagram illustrating an example of a result of a correlation process in a phase direction in the related art.

FIG. 13 is a diagram illustrating an example of a result of a correlation process in a phase direction and in a frequency direction according to a first embodiment.

FIG. 14 is a diagram illustrating an example of a result of a correlation process in a frequency direction according to the first embodiment.

FIG. 15 is a diagram illustrating an example of a result of a correlation process in a phase direction according to the first embodiment.

FIG. 16 is a flowchart illustrating a work flow of a fifth correlation process.

FIG. 17 is a flowchart illustrating a work flow of a sixth correlation process.

FIG. 18 is a diagram illustrating an example of a time-series change in correlation values in the related art.

FIG. 19 is a diagram illustrating an example of a time-series change in correlation values according to a second embodiment.

### DESCRIPTION OF EXEMPLARY EMBODIMENTS

### 1. Principle

Firstly, a principle of a satellite signal acquisition according to the present embodiment will be described.

In a position calculation system using a GPS satellite, the GPS satellite which is a type of positioning satellite transmits navigation message data including satellite orbit data such as an almanac or an ephemeris, through a GPS satellite signal which is a type of positioning satellite signal.

The GPS satellite signal is a communication signal of 1.57542 GHz modulated by CDMA (Code Division Multiple Access) which is known as a spectrum spread technique, using CA (Coarse and Acquisition) codes which are a type of spread code. The CA codes are pseudo random noise codes in a repetitive cycle of 1 ms in which a code length of 1023 chips is set to one PN frame, which are different according to each satellite.

Frequency (regulated carrier frequency) at the time when the GPS satellite transmits the GPS satellite signal is regulated in advance as 1.57542 GHz. However, due to the Doppler effect or the like generated by the movement of the GPS satellite or a GPS receiver, the frequency at the time when the GPS receiver receives the GPS satellite signal does not necessarily coincide with the regulated carrier frequency. Thus, the GPS receiver in the related art performs a frequency search which is a correlation operation in a frequency direction for acquiring the GPS satellite signal from received signals to acquire the GPS satellite signal. Further, in order to specify a phase of the received GPS satellite signal (CA codes), the GPS receiver performs a phase search which is a correlation operation in a phase direction to acquire the GPS satellite signal.

However, in particular, in a weak electric field environment such as an indoor environment, since the level of a correlation value in a true reception frequency and a true code phase is lowered, it is difficult to distinguish it from noise. As a result, detection of the true reception frequency and the true code phase, that is, signal acquisition becomes difficult. Thus, under such a reception environment, a technique is used in which correlation values obtained by the correlation operation are integrated over a predetermined correlation integration time and a peak is detected from the integrated correlation values to acquire the GPS satellite signal.

However, the GPS satellite signal is spread modulated by the CA codes, and the CA codes themselves are BPSK (Binary Phase Shift Keying) modulated according to a bit value of navigation message data. Since the bit length of the navigation message data is 20 milliseconds, there is a possibility that the bit value is changed (inverted) every 20 milliseconds. The possibility means that the bit value may not be changed. In this embodiment, the timing when the bit value of the navigation message data is actually changed is referred to as “bit inversion timing”.

That the bit value of the navigation message data is changed means that polarity of the CA codes is inverted. Thus, if a correlation operation of the received CA codes and replica codes is performed, correlation values having different signs can be calculated every 20 milliseconds which is the bit length of the navigation message data. Accordingly, if the correlation values are integrated over the bit inversion timing of the navigation message data, correlation values having different signs are offset against each other, and thus, a problem that the correlation values become significantly small (in an extreme case, 0) occurs. In order to solve this problem, the present inventor contrived a new technique of integrating the correlation values with same signs, using a frequency analysis for the correlation values.

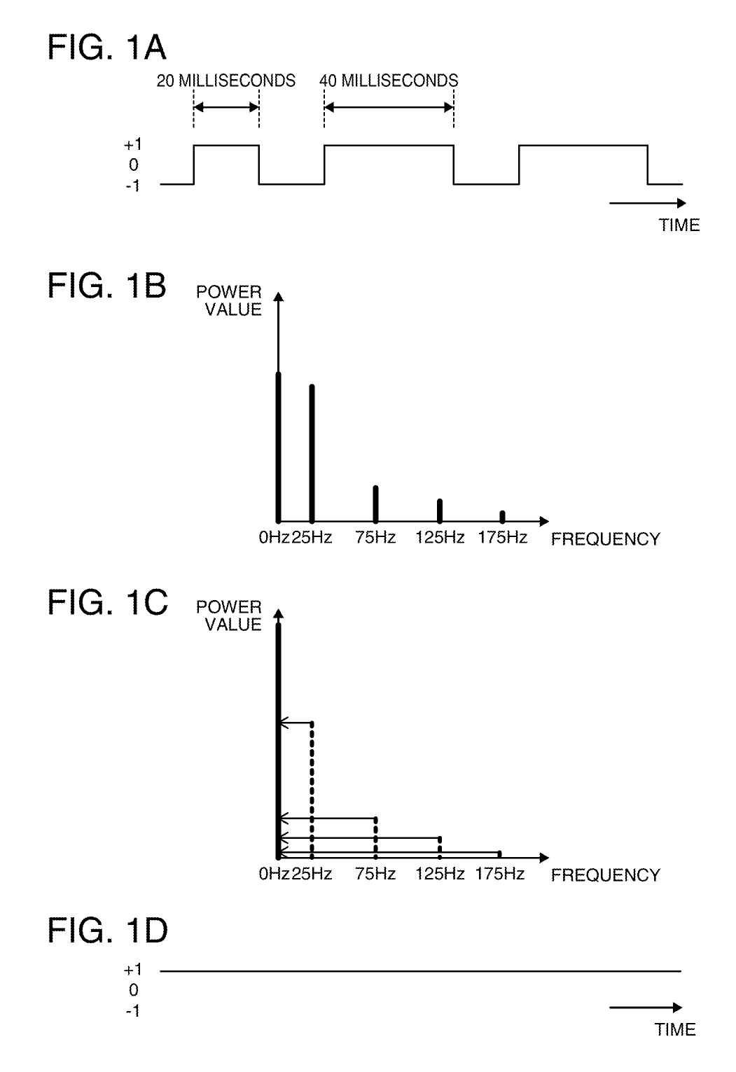

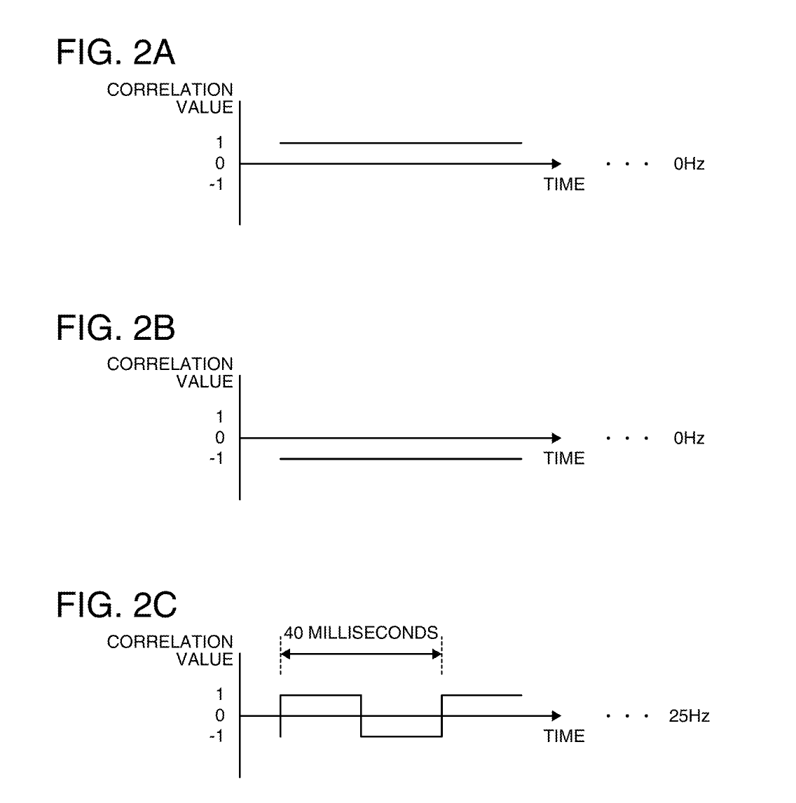

FIGS. 1A to 1D and FIGS. 2A to 2C are diagrams illustrating a work flow of a correlation process according to the embodiment.

FIG. 1A illustrates an example of a time-series change in correlation values. For ease of description, the correlation values are expressed as two positive and negative values, for example, “+1” and “−1”. Further, a case where a true value of a reception frequency is already known and a correlation operation is performed using replica codes which coincide with received CA codes in phase to calculate the correlation values, will be described hereinafter.

If the polarity of the CA code in a case where the bit value of the navigation message data is “1” is positive, the received CA code is multiplied by the replica code, and thus, the correlation value “+1” is obtained. On the other hand, if the polarity of the CA code in a case where the bit value of the navigation message data is “0” is negative, the received CA code is multiplied by the replica code, and thus, the correlation value “−1” is obtained.

Referring to FIG. 1A, it can be understood that the signs of the correlation values are switched at the bit inversion timing of the navigation message data. In a case where the bit inversion timing comes after 20 milliseconds from the previous bit inversion timing, according to the bit value, the sign of the correlation value is inverted at the timing after 20 milliseconds. Further, in a case where the bit inversion timing comes after 40 milliseconds, the sign of the correlation value is inverted at the timing after 40 milliseconds.

If the time-series correlation values shown in FIG. 1A are integrated over a predetermined time which is equal to or longer than the bit length and the frequency analysis is performed, a power spectrum as shown in FIG. 1B is obtained, for example. As described later in the embodiment, as the frequency analysis, for example, a Fourier transform or a wavelet transform can be used. In FIG. 1B, the transverse axis represents frequency, and the longitudinal axis represents a power value. For ease of description, white noise is not shown.

As shown in FIG. 1B, a peak of a power value appears in a zero frequency (0 Hz). This is direct-current components of the time-series correlation values. That is, as shown in FIGS. 2A and 2B, frequency components (direct-current components) corresponding to a portion where the sign is not changed, among the time-series correlation values, appear as the peak of the power value of 0 Hz.

However, as shown in FIG. 1B, a peak having a large power value also appears in a frequency of 25 Hz. This is caused by the fact that the bit length of the navigation message data is 20 milliseconds. That is, as shown in FIG. 2C, in a case where the bit value of the navigation message data is changed every 20 milliseconds, for example, since the correlation values are changed to “1” in initial 20 milliseconds, “−1” in the next 20 milliseconds, “1” in the second next 20 milliseconds, the period of the correlation values becomes 40 milliseconds.

The period of 40 milliseconds is a period corresponding to two times of the bit length of the navigation message data. If the cycle of 40 milliseconds is converted into frequency, “f=1/T=1/(40×10⁻³)=25 Hz”. Frequency components of 25 Hz included in the time-series correlation values appear as the peak of the power value. In this embodiment, the frequency of 25 Hz is defined as a “specific frequency”.

Further, referring to FIG. 1B, it can be understood that small peaks, which are not as large as the specific frequency (25 Hz), appear in higher frequencies such as 75 Hz, 125 Hz and 175 Hz. A waveform of the correlation values is symmetric, and thus, the peak of the power value appears in the frequency of an odd multiple of the specific frequency which is a fundamental frequency, that is, in the odd-order harmonic frequency.

The peak of the power value in the specific frequency is caused by the fact that the polarity of the CA code is inverted at the bit inversion timing of the navigation message data and then the sign of the correlation value is changed. For example, in a case where the frequency analysis is performed by setting the integration time of the correlation values to shorter than 20 milliseconds of the bit length in order not to exceed the bit inversion timing, the peak appears only at the zero frequency and the peak does not appear in the specific frequency. That is, if the sign of the correlation value is not changed, the peak of the power value in the specific frequency does not appear. In other words, if the peak of the specific frequency can disappear, it is possible to ignore the sign change of the correlation value, and further, to negate the affect of the bit inversion of the navigation message data.

Thus, in the present embodiment, as shown in FIG. 1C, a process is performed for adding the power value in the specific frequency and its harmonics (frequency of an odd multiple of the specific frequency) to the power value in the zero frequency (0 Hz) and then setting the power value in the specific frequency and its harmonics to “0”. After such a process is performed, the time-series correlation values are reconfigured by performing an inverse frequency analysis.

Then, as shown in FIG. 1D, the time-series correlation values with no sign change are obtained. If the correlation values with no sign change are integrated, the problem that the correlation values are offset against each other and thus that the integration correlation value becomes small does not occur. Accordingly, the above-described correlation process is performed, and thus, it is possible to set the correlation integration time to be longer than 20 milliseconds which is the bit length of the navigation message data, and to integrate the correlation values for an arbitrary correlation integration time.

In FIG. 1C, the power value in the specific frequency and its harmonics is added to the power value in the zero frequency (0 Hz), but only the power value in the specific frequency may be added thereto, without addition of the power value in the harmonics of the specific frequency. This is because the power value of the harmonics is lower than the power value in the specific frequency as a whole.

### 2. Embodiments

Next, embodiments in a case where the invention is applied to a mobile phone which is a type of electronic device including a satellite signal acquisition device and a position calculation device will be described. It is obvious that embodiments to which the invention can be applied are not limited to the following embodiments.

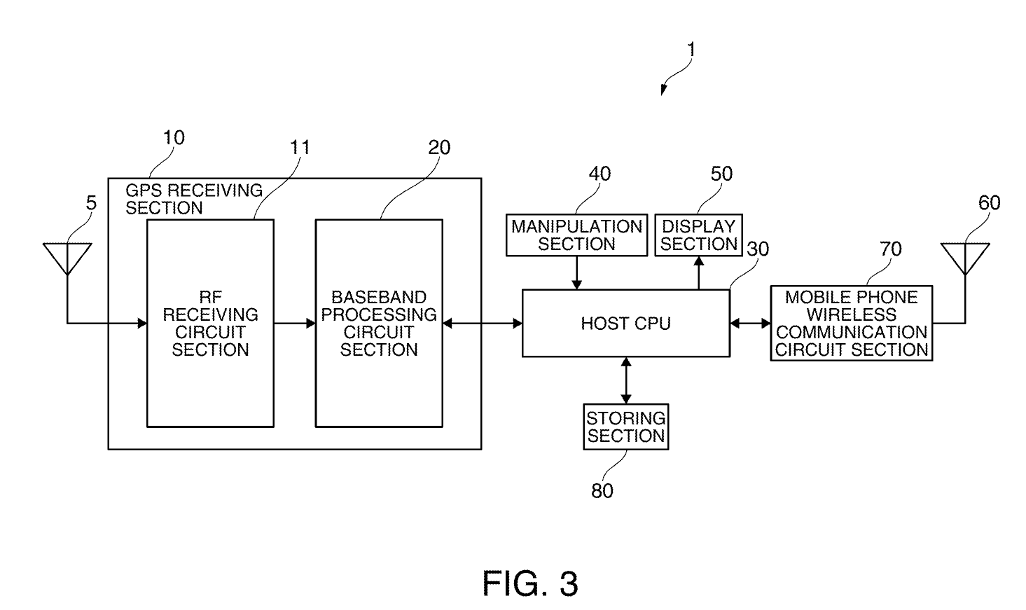

FIG. 3 is a block diagram illustrating an example of a functional configuration of a mobile phone 1 in each embodiment. The mobile phone 1 includes a GPS antenna 5, a GPS receiving section 10, a host CPU (Central Processing Unit) 30, a manipulation section 40, a display section 50, a mobile phone antenna 60, a mobile phone wireless communication circuit section 70, and a storing section 80.

The GPS antenna 5 receives an RF (Radio Frequency) signal including a GPS satellite signal transmitted from the GPS satellite, and outputs the received signal to the GPS receiving section 10.

The GPS receiving section 10 is a position calculation circuit or a position calculation device which calculates the position of the mobile phone 1 on the basis of the signal output from the GPS antenna 5, which is a functional block corresponding to a so-called GPS receiver. The GPS receiving section 10 includes an RF receiving circuit section 11 and a baseband processing circuit section 20. The RF receiving circuit section 11 and the baseband processing circuit section 20 may be manufactured as different LSIs (Large Scale Integration) or one chip.

The RF receiving circuit section 11 is a circuit which receives an RF signal. For example, a receiving circuit which converts the RF signal output from the GPS antenna 5 into a digital signal by an A/D converter and processes the digital signal may be used as the circuit configuration. Further, a configuration may be used in which the RF signal output from the GPS antenna 5 is processed as an analog signal as it is and is finally A/D converted, and then the digital signal is output to the baseband processing circuit section 20.

In the latter case, for example, it is possible to configure the RF receiving circuit section 11 as follows. That is, a predetermined oscillation signal is frequency-divided or frequency-multiplied, to generate an oscillation signal of RF signal multiplication. Then, the RF signal output from the GPS antenna 5 is multiplied by the generated oscillation signal to be down-converted into a signal of an intermediate frequency (hereinafter, referred to as an IF (Intermediate Frequency) signal). Then, the IF signal undergoes amplification and the like, is converted into a digital signal by the A/D converter, and then is output to the baseband processing circuit section 20.

The baseband processing circuit section 20 performs a correlation process or the like for the received signal output from the RF receiving circuit 11 to acquire the GPS satellite signal, and performs a predetermined position calculation on the basis of satellite orbit data, time data and the like extracted from the GPS satellite signal to calculate the position (position coordinates) of the mobile phone 1. The baseband processing circuit section 20 functions as the satellite signal acquisition device which acquires the GPS satellite signal from the received signals.

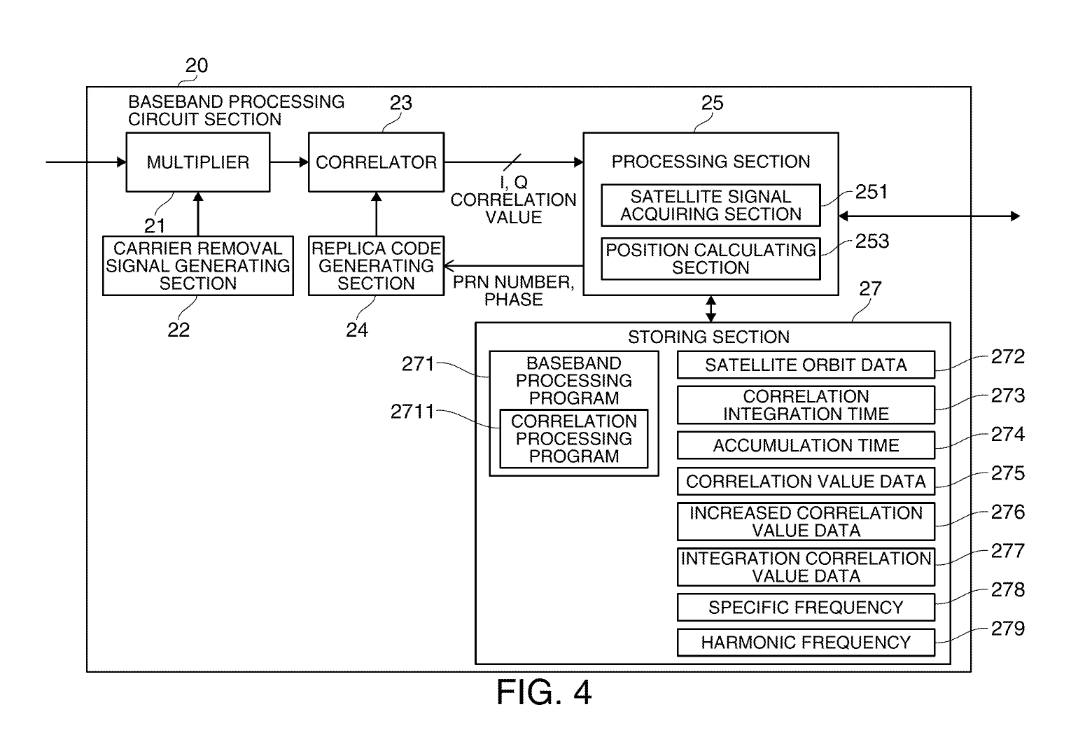

FIG. 4 is a diagram illustrating an example of a circuit configuration of the baseband processing circuit section 20, which mainly illustrates a circuit block according to this embodiment. For example, the baseband processing circuit section 20 includes a multiplier 21, a carrier removal signal generating section 22, a correlator 23, a replica code generating section 24, a processing section 25, and a storing section 27.

The multiplier 21 removes a carrier from the received signal by multiplying the received signal by a carrier removal signal generated by the carrier removal signal generating section 22, and outputs the result to the correlator 23.

The carrier removal signal generating section 22 generates a carrier removal signal which is a signal of the same frequency as the carrier signal of the GPS satellite signal, and includes an oscillator such as a carrier NCO (Numerical Controlled Oscillator) or the like, for example. In a case where the signal output from the RF receiving circuit section 11 is the IF signal, the signal is generated using an IF frequency as a carrier frequency. The carrier removal signal generating section 22 is a circuit which generates the carrier removal signal of the same frequency as the frequency of the signal output from the RF receiving circuit section 11.

The correlator 23 performs a correlation operation of a replica code generation signal generated by the replica code generating section 24 and a received signal output from the multiplier 21 from which the carrier is removed, which corresponds to a correlation operation section.

The replica code generating section 24 is a circuit section which generates the replica codes of the CA codes which are the spread codes of the GPS satellite signal, and for example, includes an oscillator such as a code NCO or the like. The replica code generating section 24 generates the replica codes according to a PRN number (satellite number) instructed from the processing section 25, by adjusting an output phase (time) according to an instructed phase, and outputs the generated replica codes to the correlator 23.

The correlator 23 performs the correlation process of respective “I” and “Q” components of the received signal and the replica codes input from the replica code generating section 24. The “I” component represents the same phase component (real part) of the received signal and the “Q” component represents a perpendicular component (imaginary part) of the received signal.

A circuit block which performs separation of I and Q components (IQ separation) of the received signal is not shown, and may be configured in a variety of methods. For example, when the received signal is down-converted into the IF signal in the RF receiving circuit section 11, the IQ separation may be performed by multiplying the received signal by a local oscillation signal having a different phase of 90 degrees.

The processing section 25 is a control device which controls respective functional sections of the baseband processing circuit section 20 as a whole, and includes a processor such as a CPU, for example. The processing section 25 functions as an analysis section which frequency-analyzes the result of the correlation operation output from the correlator 23, and also functions as an extracting section which extracts the power value in the specific frequency or the harmonic frequency or an acquiring section which acquires the GPS satellite signal from the received signal, on the basis of the frequency analysis result. As main functional sections, the processing section 25 includes a satellite signal acquiring section 251 and a position calculating section 253.

The satellite signal acquiring section 251 performs a process of integrating the correlation values output from the correlator 23 over the correlation integration time, and acquires the GPS satellite signal on the basis of the integrated correlation values (integration correlation value).

The position calculating section 253 is a calculating section which calculates the position of the mobile phone 1 by performing the known position calculation using the GPS satellite signal acquired by the satellite signal acquiring section 251, which outputs the calculated position to the host CPU 30.

The storing section 27 includes storing devices (memory) such as a ROM (Read Only Memory), a flash ROM, a RAM (Random Access Memory), and stores a system program of the baseband processing circuit section 20, or various programs, data or the like for realizing a variety of functions such as a satellite signal acquisition function, a position calculation function or the like. Further, the storing section 27 includes a work area in which data being processed in a variety of processes, processed results, and the like are temporarily stored.

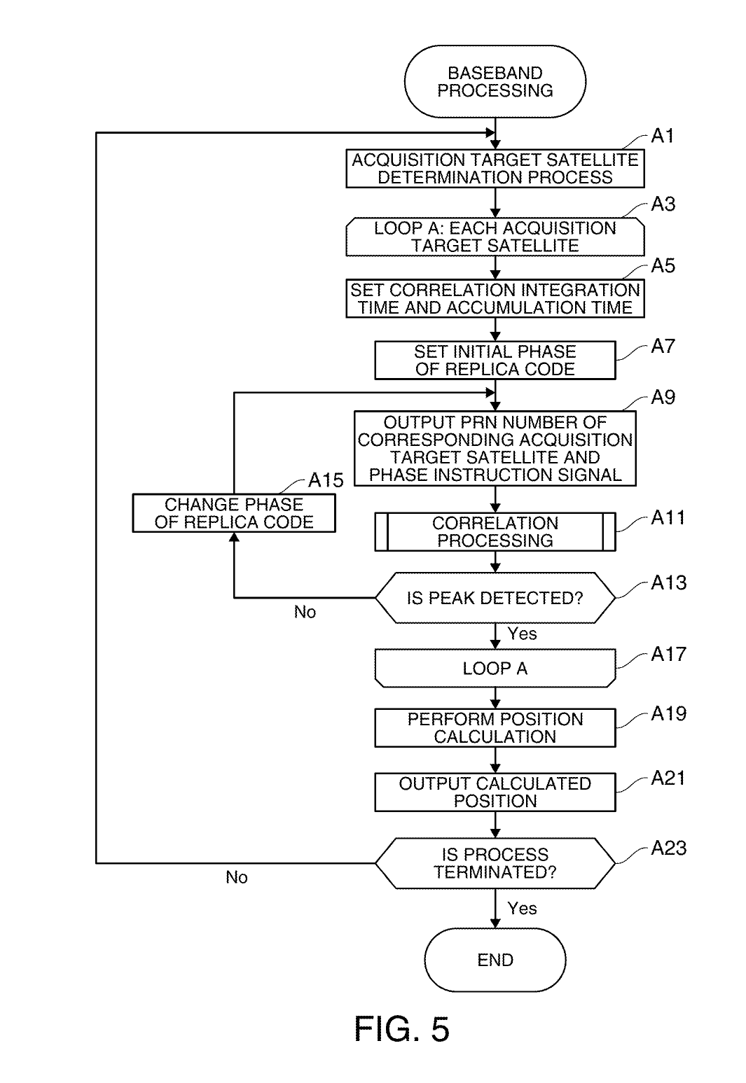

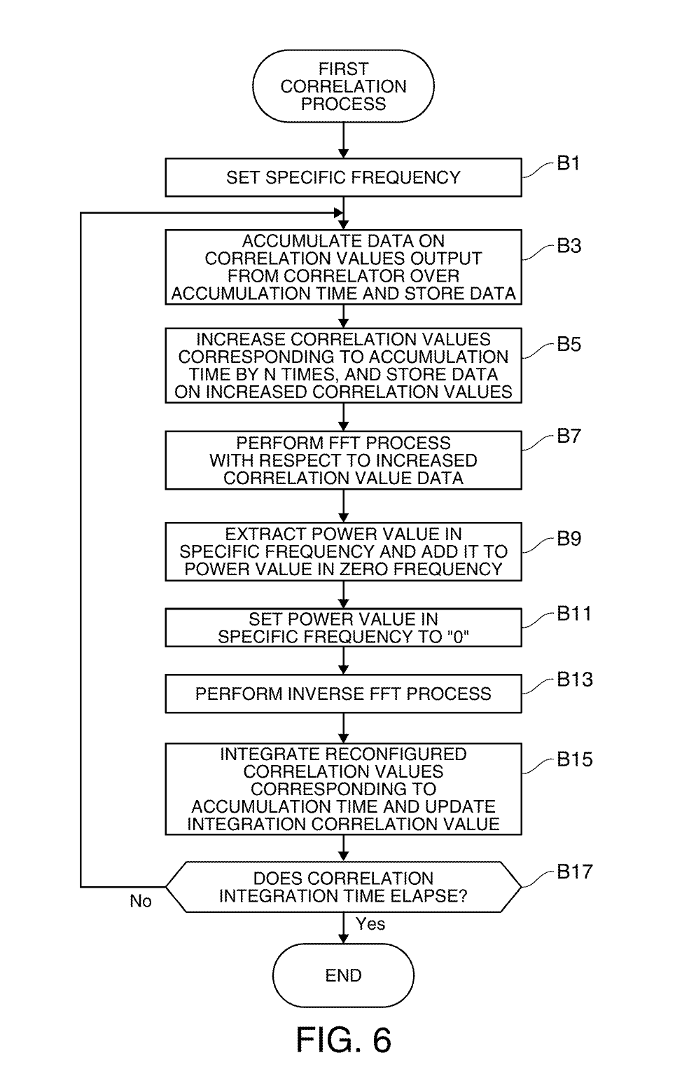

For example, as shown in FIG. 4, a baseband processing program 271 which is read out by the processing section 25 as a program and is executed as a baseband processing (see FIG. 5) is stored in the storing section 27. The baseband processing program 271 includes a correlation processing program 2711 executed as a variety of correlation processes (see FIGS. 6 to 9, FIGS. 16 and 17) as a sub-routine.

Further, as the temporarily stored data, for example, satellite orbit data 272, a correlation integration time 273, an accumulation time 274, correlation value data 275, increased correlation value data 276, integration correlation value data 277, a specific frequency 278, and a harmonic frequency 279 are stored in the storing section 27.

The baseband processing is a process in which the processing section 25 performs a variety of correlation processes with respect to each GPS satellite which is an acquisition target (hereinafter, referred to as an “acquisition target satellite”), performs a process of acquiring the GPS satellite signal, and performs the position calculation using the acquired GPS satellite signal, to thereby calculate the position of the mobile phone 1.

Further, the correlation process is a process in which the processing section 25 performs the frequency analysis for the time-series correlation values according to the above-described principle, and reconfigures the time-series correlation values by the inverse frequency analysis by considering the power value in the specific frequency or the harmonic frequency as the power value in the zero frequency. Then, the integration correlation value is obtained by integrating the reconfigured time-series correlation values. These processes will be described in detail with reference to flowcharts.

The satellite orbit data 272 is data such as an almanac in which schematic satellite orbit information about all GPS satellites is stored, an ephemeris in which detailed satellite orbit information about each satellite is stored, or the like. The satellite orbit data 272 is obtained by decoding the GPS satellite signal received from the GPS satellite, and for example, is obtained as assistance data from a base station of the mobile phone 1 or an assistance server.

The correlation integration time 273 is the time when the correlation values accumulated over the accumulation time 274 are integrated, and is variably set on the basis of information on the signal strength of the received signal, a reception environment or the like. Further, the accumulation time 274 is the time when the correlation values output from the correlator 23 are accumulated, and is set to time of a 1/m multiple (m>1) of the correlation integration time 273, for example.

The correlation value data 275 is data in which the correlation values output from the correlator 23 are accumulated over the accumulation time 274. Further, the increased correlation value data 276 is data on the increased correlation values obtained by increasing the correlation values corresponding to the accumulation time by n times (n>1). In this embodiment, in order to increase a power spectrum density obtained in the frequency analysis, the frequency analysis is performed for the increased correlation value data 276.

The integration correlation value 277 is data on the integration correlation value obtained by integrating the correlation values reconfigured by the inverse frequency analysis.

The specific frequency 278 is determined according to the bit length of the navigation message data. In this embodiment, as described in the principle, 25 Hz obtained by converting the cycle of 40 milliseconds of the correlation values corresponding to two times the bit length into frequency is used as the specific frequency. Further, the harmonic frequency 279 is a harmonic frequency of an odd multiple of the specific frequency 278.

Returning to the functional block in FIG. 3, the host CPU 30 is a processor which generally controls the respective sections of the mobile phone 1 according to a variety of programs such as a system program stored in the storing section 80. The host CPU 30 displays a map which represents a current position on the display section 50 on the basis of the position coordinates output from the baseband processing circuit section 20, or uses the position coordinates for various application processes.

The manipulation section 40 is an input device including, for example, a touch panel, a button switch or the like, and outputs a signal of a pressed key or button to the host CPU 30. Through the manipulation of the manipulation section 40, a variety of instructions such as a call request, a mail transmission/reception request, a position calculation request or the like are input.

The display section 50 includes an LCD (Liquid Crystal Display) or the like, and is a display device which performs various displays based on a display signal input from the host CPU 30. A position display screen, time information or the like is displayed on the display section 50.

The mobile phone antenna 60 is an antenna which performs transmission and reception of wireless signals for a mobile phone through a wireless base station installed by a communication service provider of the mobile phone 1.

The mobile phone wireless communication circuit section 70 is a communication circuit section of the mobile phone including an RF conversion circuit, a baseband processing circuit or the like, and realizes communication, mail transmission/reception or the like by performing modulation and demodulation or the like for the mobile phone wireless signal.

The storing section 80 is a storing device which stores a system program by which the host CPU 30 controls the mobile phone 1, or various programs, data or the like for performing various application processes.

### 2-1. First embodiment

In the first embodiment, the correlation process using the Fourier transform which is a type of the frequency analysis is performed, and the GPS satellite signal is acquired on the basis of the integration correlation value obtained by integrating the reconfigured correlation values.

### (1) Process Flow

FIG. 5 is a flowchart illustrating a work flow of baseband processing performed in the baseband processing circuit section 20, as the baseband processing program 271 stored in the storing section 27 is read out by the processing section 25.

Firstly, the satellite signal acquiring section 251 performs an acquisition target satellite determination process (step A1). Specifically, at a current time measured by a time piece (not shown), the satellite signal acquiring section 251 determines a GPS satellite positioned in a predetermined reference position in the sky using the satellite orbit data 272 such as an almanac or an ephemeris stored in the storing section 27, as the acquisition target satellite. For example, in a case of the first position calculation after power supply, the reference position may be set to a position obtained from the assistance server by so-called server assistance. Further, in a case of the second position calculation and thereafter, the reference position may be set to a latest calculation position.

Then, the satellite signal acquiring section 251 performs a process of a loop A with respect to each acquisition target satellite determined in step A1 (steps A3 to A17). In the process of the loop A, the satellite signal acquiring section 251 sets the correlation integration time 273 and the accumulation time 274 with respect to the acquisition target satellite (step A5).

The setting of the correlation integration time may be realized by various methods. For example, the setting may be performed on the basis of the signal strength of the received signal from the acquisition target satellite. As the signal strength is weaker, it is more difficult to detect the peak of the correlation values if the correlation values are not integrated over a longer time. Thus, the correlation integration time may be preferably set so that the correlation integration time is increased as the signal strength becomes weak.

Further, the reception environment of the GPS satellite signal may be determined, and then the correlation integration time may be determined on the basis of the determined reception environment. For example, in a case where the reception environment is an “indoor environment”, the correlation integration time may be set to a long “1000 milliseconds”, and in a case where the reception environment is an “outdoor environment”, the correlation integration time may be set to a short “200 milliseconds”.

Further, the accumulation time is set so that the correlation integration time becomes a time of an integer multiple of the accumulation time. That is, time of a 1/m multiple (m>1) of the correlation integration time is set to the accumulation time. The value of “m” can be appropriately set. For example, in a case where the correlation integration time is set to “1000 milliseconds” and “m” is 25, the accumulation time may be set to 40 milliseconds.

Subsequently, the satellite signal acquiring section 251 sets an initial phase of the replica code (step A7). Then, the satellite signal acquiring section 251 outputs an instruction signal which instructs a PRN number of the acquisition target satellite and a phase of the replica code to the replica code generating section 24 (step A9). Further, the satellite signal acquiring section 251 performs the correlation process by reading out and executing the correlation processing program 2711 stored in the storing section 27 (step A11).

FIG. 6 is a flowchart illustrating a work flow of a first correlation process which is an example of the correlation process.

Firstly, the satellite signal acquiring section 251 sets the specific frequency 278 and stores it in the storing section 27 (step B1). As described in the principle, the specific frequency 278 sets “40 milliseconds” which is the period of two times of the bit length of the navigation message data as one cycle, to thereby set “25 Hz” which is the frequency corresponding to one cycle.

Then, the satellite signal acquiring section 251 stores the data obtained by accumulating the correlation values output from the correlator 23 over the accumulation time set in step A5 in the storing section 27 as the correlation value data 275 (step B3). Then, the satellite signal acquiring section 251 calculates the increased correlation values by increasing the correlation values corresponding to the accumulation time by n times (n>1), and stores them in the storing section 27 as the increased correlation value data 276 (step B5).

Next, the satellite signal acquiring section 251 performs an FFT (Fast Fourier Transform) process with respect to the increased correlation value data 276 (step B7). Since the process relating to the FFT is already known in the related art, detailed description thereof will be omitted.

If the power spectrum in a frequency area is calculated through the FFT process, the satellite signal acquiring section 251 extracts the power value in the specific frequency set in step B1, and adds it to the power value in the zero frequency (0 Hz) (step B9). Further, the satellite signal acquiring section 251 sets the power value in the specific frequency 278 to “0” (step B11).

Then, the satellite signal acquiring section 251 performs an IFFT (Inverse Fast Fourier Transform) process to reconfigure the correlation values (step B13). Since the inverse fast Fourier transform process is already known in the related art, detailed description thereof will be omitted.

If the correlation values are reconfigured through the IFFT process, the satellite signal acquiring section 251 integrates the reconfigured correlation values corresponding to the accumulation time, and updates the integration correlation value data 277 in the storing section 27 (step B15). That is, the satellite signal acquiring section 251 integrates the reconfigured correlation values corresponding to the accumulation time and adds them to the latest integration correlation value.

Then, the satellite signal acquiring section 251 determines whether the correlation integration time 273 set in step A5 elapses (step B17). If it is determined that the correlation integration time 273 does not elapse (step B17; No), the procedure returns to step B3. Further, if it is determined that the correlation integration time elapses (step B17; Yes), the first correlation process is terminated.

Returning to the baseband processing in FIG. 5, after performing the correlation process, the satellite signal acquiring section 251 performs the peak detection for the integration correlation value data 277 in the storing section 27 (step A13). If it is determined that the peak is not detected (step A13; No), the phase of the replica code is changed (step A15), and then the procedure returns to step A9.

Further, if it is determined that the peak is detected (step A13; Yes), the satellite signal acquiring section 251 transits the process to the next acquisition target satellite. Then, after performing the processes of steps A5 to A15 with respect to all the acquisition target satellites, the satellite signal acquiring section 251 terminates the process of the loop A (step A17).

Then, the position calculating section 253 performs the position calculation using the GPS satellite signal acquired with respect to each acquisition target satellite (step A19). The position calculation may be realized by performing a known convergence operation, for example, using the least-square method or the Kalman filter, on the basis of a pseudo distance between the mobile phone 1 and each acquisition satellite.

The pseudo distance can be calculated as follows. That is, an integer part of the pseudo distance is calculated using the satellite position of the acquisition satellite calculated from the satellite orbit data 272 and the latest calculation position of the mobile phone 1. Further, a fractional part of the pseudo distance is calculated using the phase (code phase) of the replica code corresponding to the peak of the correlation values detected in step A13. The pseudo distance can be calculated by summing the integer part and the fractional part which are calculated in this way.

Subsequently, the position calculating section 253 outputs the calculated position (position coordinates) to the host CPU 30 (step A21). Then, the processing section 25 determines whether the process is terminated (step A23). If it is determined that the process is not yet terminated (step A23; No), the procedure returns to step A1. Further, if it is determined that the process is terminated (step A23; Yes), the baseband processing is terminated.

### (2) Experimental Result

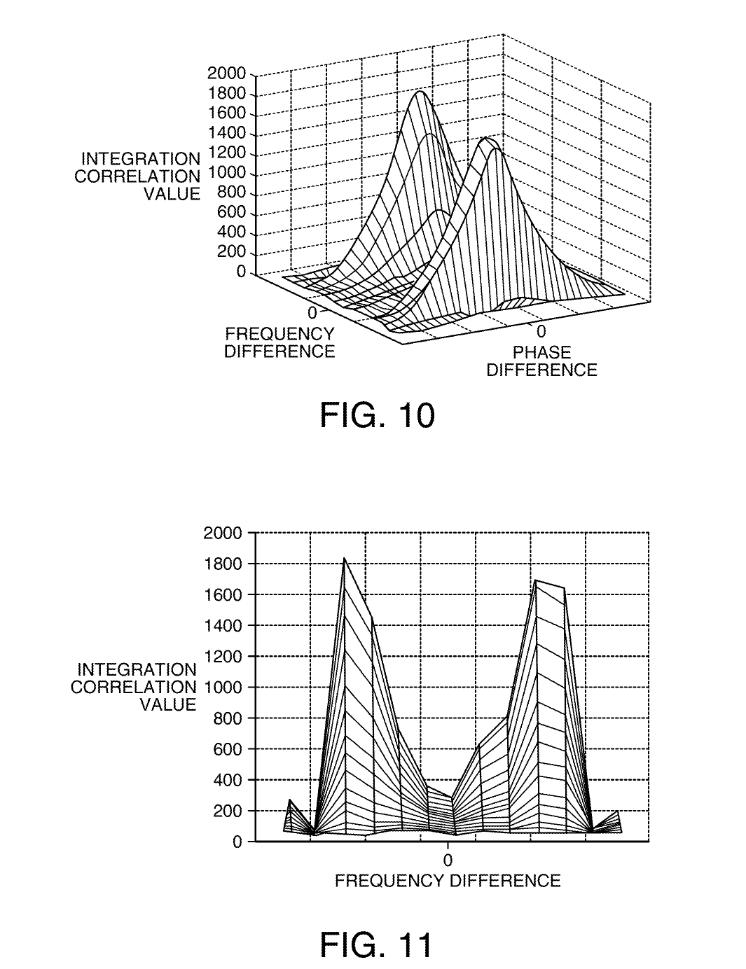

An experimental result in a case where the GPS satellite signal is acquired will be described with reference to FIGS. 10 to 15. FIGS. 10 to 12 illustrate an example of an experimental result in the case where the GPS satellite signal is acquired according to a signal acquisition method in the related art. With respect to each of a frequency direction and a phase direction, an experiment has been performed in which the integration correlation value is calculated by integrating the correlation values corresponding to 40 milliseconds for one second to thereby detect its peak.

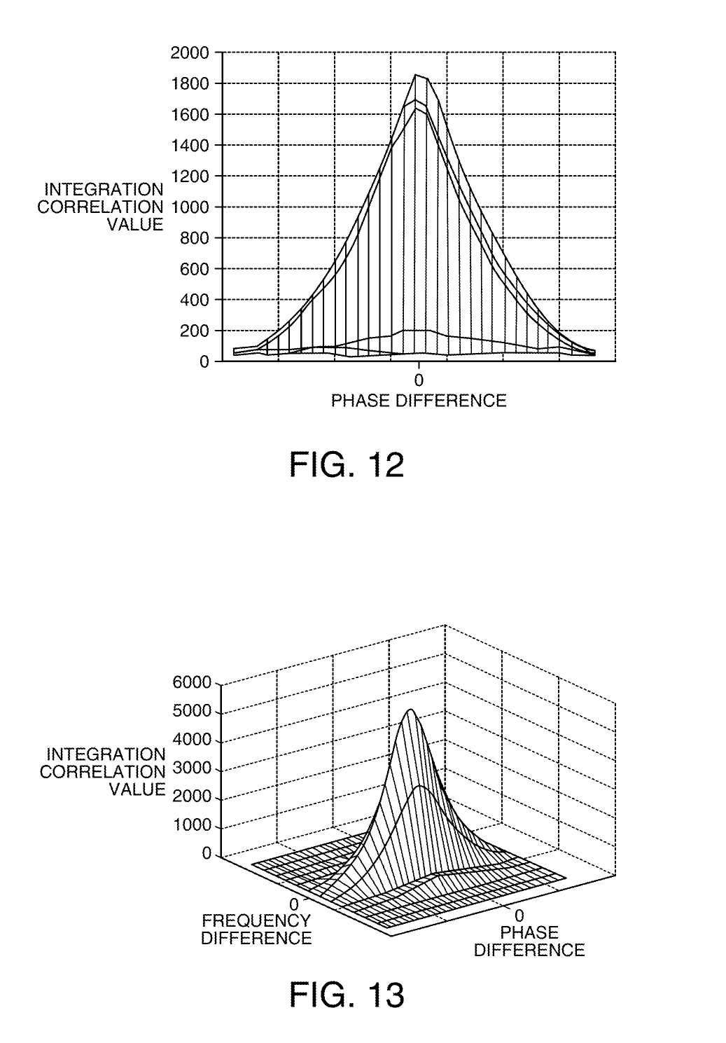

FIG. 10 is a graph illustrating the integration correlation value in the phase direction and the frequency direction, in a three-dimensional manner. In FIG. 10, a right depth direction represents a phase difference between a received CA code phase and a replica code phase, and a left depth direction represents a frequency difference between a received signal frequency and a carrier removal signal frequency. Further, the longitudinal axis represents the integration correlation value. FIG. 11 is a graph illustrating the correlation process result extracted in the frequency direction in FIG. 10, and FIG. 12 is a graph illustrating the correlation process result extracted in the phase direction in FIG. 10.

Referring to FIG. 12, it can be understood that a peak of the integration correlation value appears in a portion of a phase difference “0” with respect to the correlation process result in the phase direction and a correct result is obtained. However, referring to FIG. 11, it can be understood that the peak of the integration correlation value does not appear in the portion of the frequency difference “0 Hz” and peaks appear in frequency differences slightly spaced in the left and right directions from “0 Hz”, with respect to the correlation process result in the frequency direction. As a result of investigation of the frequency differences in which the peaks appear, it could be understood that the frequency differences are frequency differences corresponding to “±25 Hz” which is the specific frequency. That the peak does not appear in the frequency difference “0 Hz” means that the acquisition of the GPS satellite signal fails.

FIGS. 13 to 15 illustrate an example of the experimental result in a case where the GPS satellite signal is acquired according to the signal acquisition method in the first embodiment. With respect to each of the frequency direction and the phase direction, the experiment has been performed in which the above-described first correlation process is performed over the accumulation time of “40 milliseconds” and the correlation integration time of “1000 milliseconds” to calculate the integration correlation value, and its peak is detected.

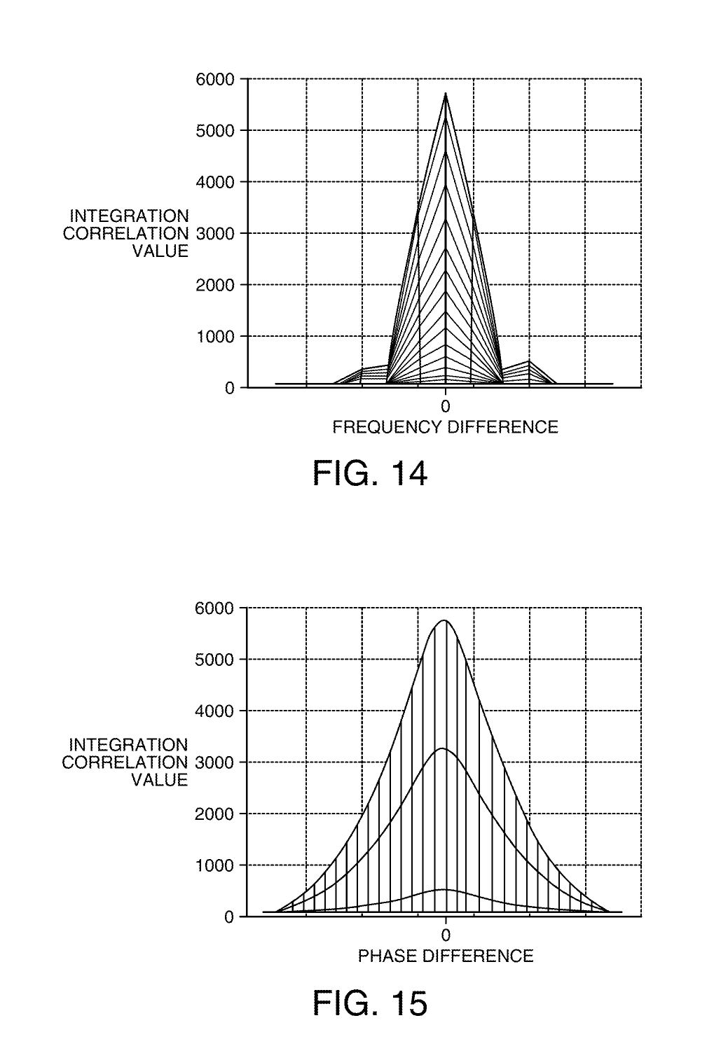

FIG. 13 is a graph illustrating the integration correlation value in the phase direction and the frequency direction, in a three-dimensional manner. Further, FIG. 14 is a graph illustrating the correlation integration result extracted in the frequency direction in FIG. 13, and FIG. 15 is a graph illustrating the correlation integration result extracted in the phase direction in FIG. 13. Estimation of the graphs is the same as in FIGS. 10 to 12.

Referring to FIG. 15, it can be understood that a peak of the integration correlation value appears in a portion of the phase difference “0”, with respect to the correlation process result in the phase direction, and a correct result is obtained. Further, referring to FIG. 14, it can be understood that a peak of the integration correlation value appears in a portion of the frequency difference “0 Hz”, with respect to the correlation process result in the frequency direction. The phase and the frequency coincide with each other, which means that the acquisition of the GPS satellite signal is successful.

### (3) Effects

In the baseband processing circuit section 20, the correlation operation is performed in the correlator 23, with respect to the received GPS satellite signal which is transmitted from the GSP satellite. Then, with respect to the correlation operation result over a predetermined accumulation time which is equal to or longer than the bit length (20 milliseconds) of the navigation message data which is carried in the GPS satellite signal, the frequency analysis based on the Fourier transform is performed by the processing section 25. Then, after the power value in the specific frequency (25 Hz) according to the bit length of the navigation message data is added to the power value in the zero frequency, and the power value in the specific frequency is set to “0”, the correlation values are reconfigured by the inverse Fourier transform. Further, the reconfigured correlation values are integrated and the GPS satellite signal is acquired on the basis of the integration correlation value.

If the bit value of the navigation message data is changed (inverted), the polarity of the CA code is also inverted. Thus, in a case where the correlation operation with respect to the replica CA code is performed, a sign change appears in the time-series data on the correlation values. Thus, if the Fourier transform is performed for the time-series data on the correlation values, as described in the principle, the peak of the power value appears in the frequency of “25 Hz” (specific frequency).

The peak of the power value in the specific frequency is caused by the change in the bit value of the navigation message data. Thus, a process of extracting the power value in the specific frequency and moving it to the power value in the zero frequency is performed. After performing such a process, the correlation values are reconfigured by the inverse Fourier transform, and thus, it is possible to obtain the time-series data on the correlation values with same signs. If the correlation values with same signs can be integrated, the correlation values having different signs are not offset against each other. Accordingly, the correlation process over the correlation integration time longer than the bit length (20 milliseconds) of the navigation message data can be realized.

Further, in this embodiment, the accumulation time when the correlation value is accumulatively stored is set to a time of a 1/m multiple (m>1) of the correlation integration time. Then, the correlation values accumulated over the accumulation time are increased by n times to calculate the increased correlation values. Further, the Fourier transform is performed for the time-series data on the increased correlation values, thereby making it possible to increase the power spectrum density and to enhance the accuracy of the frequency analysis.

As can be understood from the above-described experimental result, in a case where the acquisition of the GPS satellite signal fails, the peak of the integration correlation value appears in the frequency difference corresponding to the specific frequency, and in a case where the acquisition succeeds, the peak of the integration correlation value appears in the zero frequency difference. Hence, the power value in the specific frequency moves to the power value in the frequency zero, which means that the reception frequency of the GPS satellite signal is detected.

### (4) Other Correlation Processes

The first correlation process described with reference to FIG. 6 is an example of the correlation process, and the invention is not limited thereto. Examples of other correlation processes will be described with reference to flowcharts. In the following flowcharts, same reference numerals are given to the same steps as in the first correlation process, and thus, description thereof will be omitted. Further, different steps from the first correlation process will be mainly described.

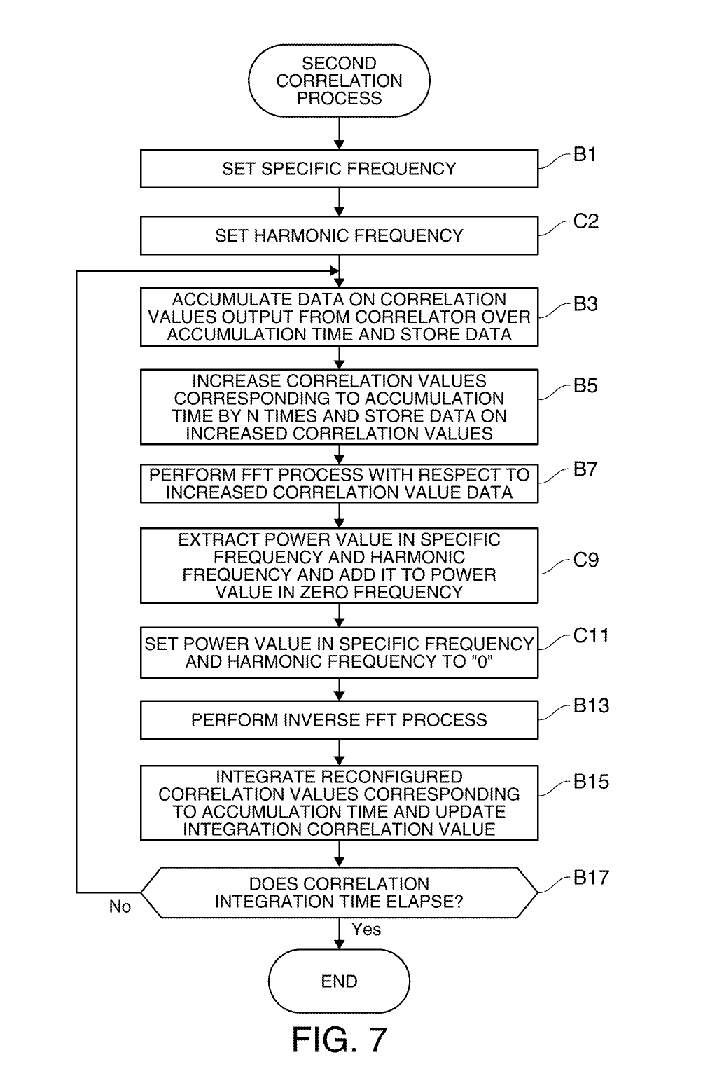

FIG. 7 is a flowchart illustrating a work flow of a second correlation process which is an example of other correlation processes. In the second correlation process, after step B1, the satellite signal acquiring section 251 sets the harmonic frequency 279 (step C2). The harmonic frequency 279 sets the frequency of an odd multiple of the specific frequency 278 set in step B1, for example.

Then, after performing the FFT process in step B7, the satellite signal acquiring section 251 extracts the power value in the specific frequency and the harmonic frequency, and adds it to the power value in the zero frequency (step C9). Further, the power value in the specific frequency and the harmonic frequency is set to “0” (step C11). Subsequent processes are the same as in the first correlation process.

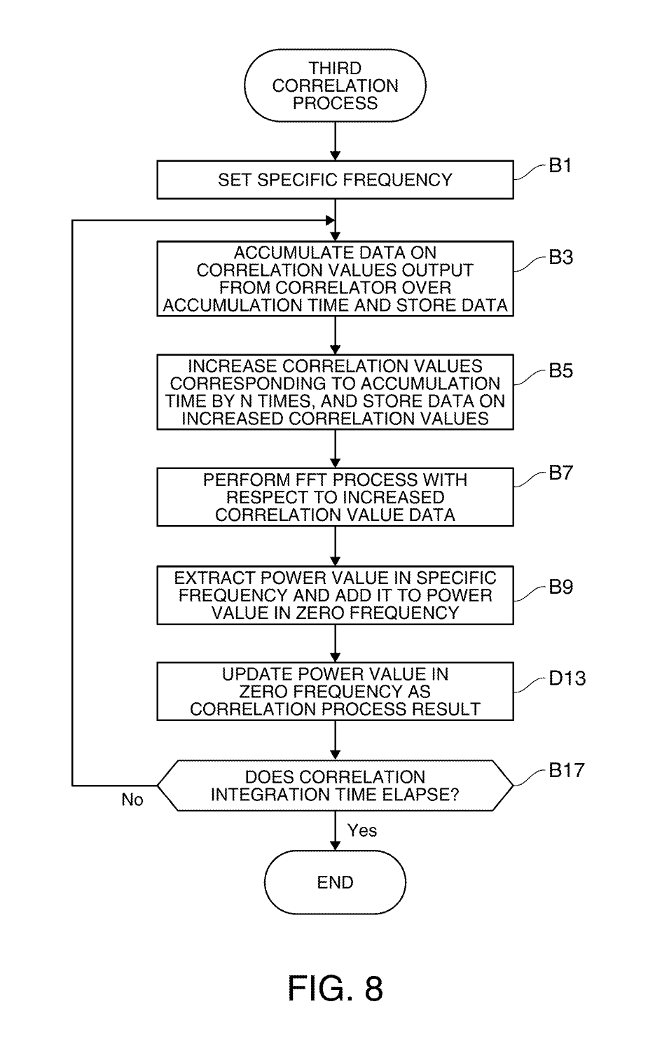

FIG. 8 is a flowchart illustrating a work flow of a third correlation process which is an example of other correlation processes. In the third correlation process, the satellite signal acquiring section 251 adds the power value in the specific frequency in step B9 to the power value in the zero frequency and then updates the power value in the zero frequency as the correlation process result, without performing the IFFT process (step D13).

In the next process, the satellite signal acquiring section 251 considers the power value in the zero frequency as the correlation process result and performs the acquisition of the GPS satellite signal. In the third correlation process, since a power value other than the power value in the zero frequency is not required, the step (step B11 in FIG. 6) in which the power value in the specific frequency of the first correlation process is set to “0” is omitted.

In this way, a reason why the power value in the zero frequency is considered as the correlation process result to perform the process will be described. When performing the Fourier transform using a calculator (computer), a discrete Fourier transform is generally used. The discrete Fourier transform for the correlation values is formulated by the following formula (1).

$${f}_{j} = {\sum }_{k = 0}^{n - 1} {x}_{k} {e}^{- \frac{2 π i}{n} j k} \\ j = 0 , 1 , 2 , … , n - 1 \qquad ( 1 )$$

In the formula (1), “xₖ” represents a correlation value, and a suffix “k” represents the number of sampled correlation value. Further, “fⱼ” represents a frequency, and a suffix “j=0, 1, 2, . . . , n−1” represents the number of sampled frequency.

In this case, a power value “Powerⱼ” for a j-th frequency is given according to the following formula (2).

$${Power}_{j} = \frac{{\vert {f}_{j} \vert}^{2}}{n} \qquad ( 2 )$$

Further, the inverse Fourier transform to the correlation value from the frequency is formulated by the following formula (3).

$${x}_{k} = \frac{1}{n} {\sum }_{j = 0}^{n - 1} {f}_{j} {e}^{\frac{2 π i}{n} j k} \\ k = 0 , 1 , … , n - 1 \qquad ( 3 )$$

In step B9 of the third correlation process, in a case where the power value in the zero frequency obtained by adding the power value in the specific frequency to the power value in the zero frequency (hereinafter, referred to as a “combination zero frequency power value”) is expressed as “Power′₀”, if the inverse Fourier transform is performed in consideration of only the direct-current component, the following formula (4) is obtained.

$${x}_{k} = \frac{1}{n} {f}_{0} = \frac{\sqrt{{Power}_{0}^{′} \times n}}{n} = \sqrt{\frac{{Power}_{0}^{′}}{n}} \qquad ( 4 )$$

Here, when the formula (4) is obtained, the fact that the following formula (5) is established from the formula (2) is used.

f₀=\sqrt{Power′₀×n} (5)

In a case where the accumulation time is “t”, the correlation values “xₖ” which are reconfigured in the inverse Fourier transform are integrated over the integration time “t”, to thereby obtain an integration correlation value “X” shown in the following formula (6).

$$X = t \times \sqrt{\frac{{Power}_{0}^{′}}{n}} \qquad ( 6 )$$

Referring to the formula (6), it can be understood that the integration correlation value “X” corresponding to the accumulation time depends on the accumulation time “t”, the combination zero frequency power value “Power′₀” and the total number of samplings “n”. Here, the accumulation time “t” and the total number of samplings “n” are constants. Accordingly, the integration correlation value “X” is obtained by multiplying the combination zero frequency power value “Power′₀” by times corresponding to the constants. Thus, it can be said that the combination zero frequency power value is equivalent to the correlation values which are reconfigured. Thus, the GPS satellite signal can be acquired using the combination zero frequency power value itself, without performing the inverse Fourier transform.

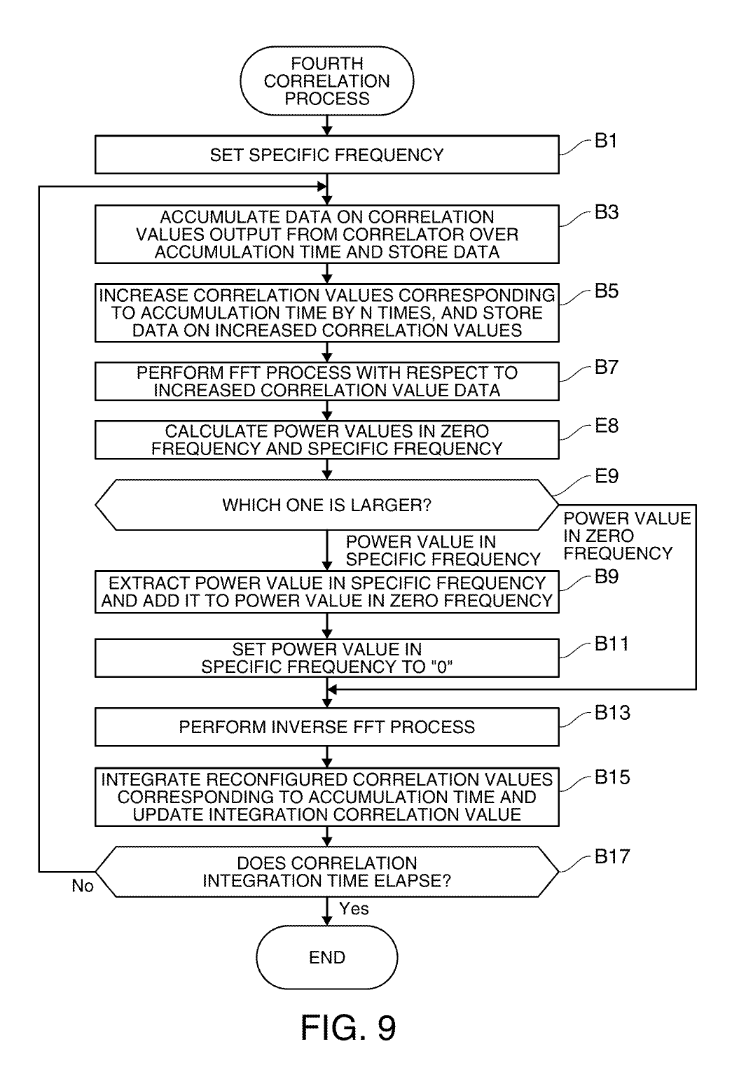

FIG. 9 is a flowchart illustrating a work flow of a fourth correlation process which is an example of other correlation processes. In the fourth correlation process, the satellite signal acquiring section 251 performs the FFT process in step B7, and then calculates the power value in the zero frequency and the power value in the specific frequency (step E8). Further, the satellite signal acquiring section 251 compares the sizes of the calculated power values (step E9).

In a case where the power value in the specific frequency is larger (step E9, the power value in the specific frequency), the satellite signal acquiring section 251 performs the processes in steps B9 and B11, and then performs the IFFT process (step B13). On the other hand, in a case where the power value in the zero frequency is larger (step E9, the power value in the zero frequency), the satellite signal acquiring section 251 performs the IFFT process as it is.

In the fourth correlation process, it is determined whether the bit inversion of the navigation message data is present or not within the accumulation time, and if the bit inversion is present, the process is changed according to a relative size of the power value in the specific frequency.

That is, if the power value in the specific frequency is larger than the power value in the zero frequency, it is determined that the bit inversion occurs within the accumulation time and the power value in the specific frequency is relatively large. In this case, the power value in the specific frequency is added to the power value in the zero frequency, and then the process continues. On the other hand, if the power value in the zero frequency is larger than the power value in the specific frequency, it is determined that the power value in the specific frequency is not relatively large or the bit inversion does not occur, and then the process continues without performing the movement of the power value.

### 2-2. Second Embodiment

In the second embodiment, a correlation process based on the wavelet transform which is a type of the frequency analysis is performed, and the GPS satellite signal is acquired on the basis of the integration correlation value obtained by integrating the reconfigured correlation values.

### (1) Process Flow

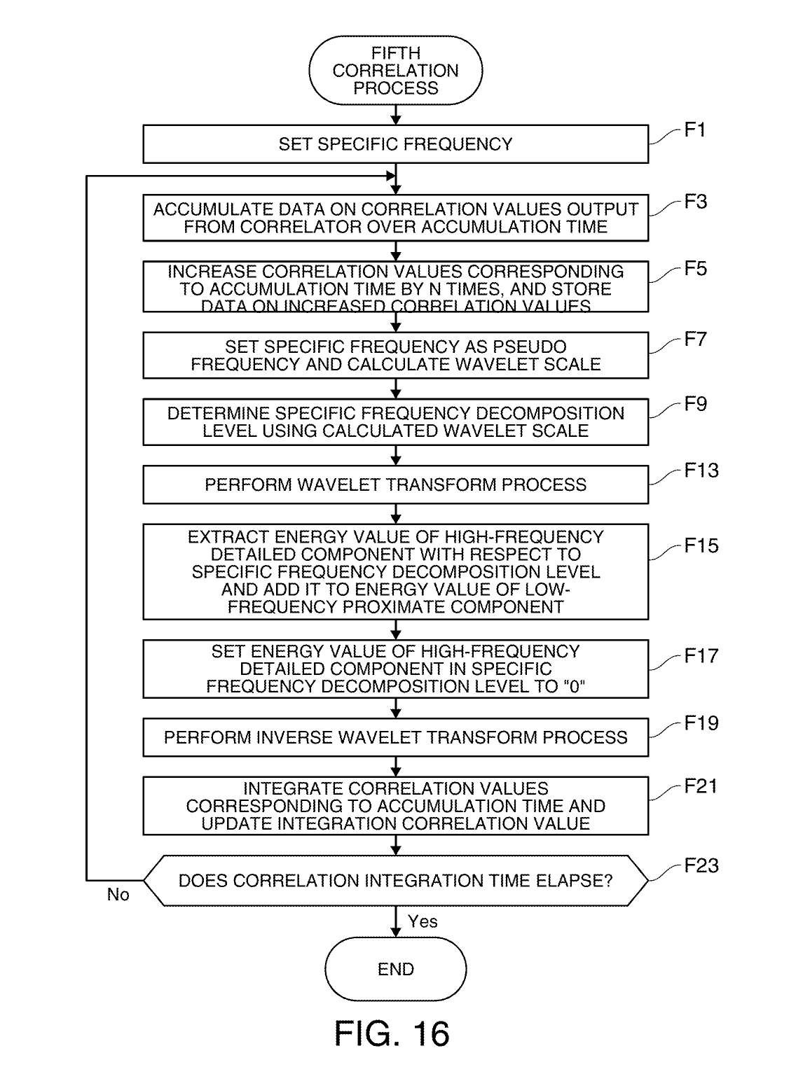

FIG. 16 is a flowchart illustrating a work flow of a fifth correlation process which is a type of the correlation process based on the wavelet transform.

Firstly, the satellite signal acquiring section 251 sets the specific frequency 278, and stores it in the storing section 27 (step F1). The specific frequency 278 is set to “25 Hz” as described in the principle.

Then, the satellite signal acquiring section 251 accumulates the correlation values output from the correlator 23 over the accumulation time, and stores them in the storing section 27 as the correlation value data 275 (step F3). Further, the satellite signal acquiring section 251 increases the correlation values corresponding to the accumulation time by n times to calculate the increased correlation values, and then stores them in the storing section 27 as the increased correlation value data 276 (step F5).

Then, the satellite signal acquiring section 251 sets the specific frequency set in step F1 as a pseudo frequency, and then calculates a wavelet scale “a” according to the following formula (7) (step F7).

$${F}_{a} = \frac{{F}_{c}}{a \cdot dT} \qquad ( 7 )$$

In the formula (7), “Fₐ” and “F_{c}” represent a pseudo frequency and a central frequency of the wavelet function, respectively. Further, “a” represents a wavelet scale, and “dT” represents a sampling cycle of an input signal.

Then, the satellite signal acquiring section 251 determines a decomposition level “J” corresponding to the specific frequency (hereinafter, referred to as a “specific frequency decomposition level”) according to the following formula (8), using the wavelet scale “a” calculated in step F7 (step F9).

J=log₂ a (8)

Next, the satellite signal acquiring section 251 performs a wavelet transform process for the increased correlation value data 276 (step F13). The wavelet transform process is a type of linear filtering, and decomposes the input signal (here, time-series data on the increased correlation values) into a detailed component of a high frequency and a proximate component of a low frequency, using two types of filters, that is, a wavelet filter “h” corresponding to a high-pass filter, and a scaling filter “g” corresponding to a low-pass filter. Then, a process of repeatedly decomposing the proximate component is performed until it reaches a predetermined decomposition level, and the input signal is expressed using the wavelet component having multiple resolutions.

Specifically, in a case where the increased time-series correlation values are “x(t)”, if the proximate component “x₀(t)” of the decomposition level “0” is decomposed up to a decomposition level “J−1” when the number of decomposition levels is “J”, the following formula (9) is obtained.

$${x}_{0} ( t ) = {x}_{1} ( t ) + {g}_{1} ( t ) \\ {x}_{1} ( t ) = {x}_{2} ( t ) + {g}_{2} ( t ) \\ ⋮ \\ {x}_{J - 1} ( t ) = {x}_{J} ( t ) + {g}_{J} ( t ) \qquad ( 9 )$$

In the following formula (9), “xⱼ(t)” represents the proximate component of the decomposition level “j”, and “gⱼ(t)” represents the detailed component of the decomposition level “j”. If a process of calculating “x_{J-2}(t)” by substituting “x_{J-1}(t)” into the formula of the decomposition level “J−2” which is one level below and calculating “x_{J-3}(t)” by substituting the calculated “x_{J-2}(t)” into the formula of the decomposition level “J−3” which is one level below is performed up to the decomposition level “0”, the increased time-series correlation values “x(t)” are expressed by the following formula (10).

$${x}_{0} ( t ) = {g}_{1} ( t ) + {g}_{2} ( t ) + … + {g}_{J} ( t ) + {x}_{J} ( t ) \\ = {\sum }_{j = 1}^{J} {g}_{j} ( t ) + {x}_{J} ( t ) \qquad ( 10 )$$

In this way, a technique of expressing the input signal using a sum of wavelet components having different resolutions is referred to as a multi-resolution analysis. In a case where the wavelet transform is realized using a calculator (computer), in order to further effectively perform the calculation, the discrete wavelet transform which selects a scale parameter “a” using power of 2 as a base is used.

After performing the wavelet transform process, the satellite signal acquiring section 251 extracts the energy value of a high-frequency detailed component with respect to the specific frequency decomposition level “J” and adds it to the energy value of a low-frequency proximate component (step F15). Further, the energy value of the high-frequency detailed component in the specific frequency decomposition level “J” is set to “0” (step F17). The energy value of the low-frequency proximate component is expressed as a square of a proximate component coefficient (scaling coefficient), and the energy value of the high-frequency detailed component is expressed as a square of a detailed component coefficient (wavelet coefficient).

Since the concept of the “energy value” is generally used in the wavelet transform, in this embodiment, a process in which the concept of the energy value is used is performed, which will be illustrated and described. However, the energy value is a type of the power value in the frequency analysis, and has the same meaning as the power value.

In the discrete wavelet transform, since the increased correlation values “x(t)” are decomposed into the proximate component and the detailed component, the energy values of the increased correlation values “x(t)” are conserved as the proximate component and the detailed component. That is, the law of energy conservation of the following formulas (11) and (12) is established.

E(x)=E(A)+E(D) (11)

∥x∥²=∥cA∥²+∥cD∥² (12)

Here, “cA” represents the proximate component coefficient (scaling coefficient), and “cD” represents the detailed component coefficient (wavelet coefficient).

In steps F15 and F17, a process is performed for extracting the energy value of the high-frequency detailed component with respect to the specific frequency decomposition level “J”, adding it to the energy value of the low-frequency proximate component, and then setting the energy value of the high-frequency detailed component to “0”. Since a total amount of the energy value is not changed, in the process according to the present embodiment, the law of energy conservation is satisfied.

Thereafter, the satellite signal acquiring section 251 performs the inverse wavelet transform process to reconfigure the increased correlation values (step F19). Then, the satellite signal acquiring section 251 integrates the reconfigured correlation values corresponding to the accumulation time and updates the integration correlation value data 277 in the storing section 27 (step F21).

Subsequently, the satellite signal acquiring section 251 determines whether the correlation integration time elapses (step F23). If it is determined that the correlation integration time does not elapse (step F23; No), the procedure returns to step F3. Further, if it is determined that the correlation integration time elapses (step F23; Yes), the fifth correlation process is terminated.

### (2) Experimental Result

An experimental result in a case where the GPS satellite signal is acquired using the technique according to the second embodiment will be described. Here, a result obtained by performing the correlation process between the received CA code and the replica CA code is shown, assuming that the frequency of the received signal and the phase of the received CA code are already known.

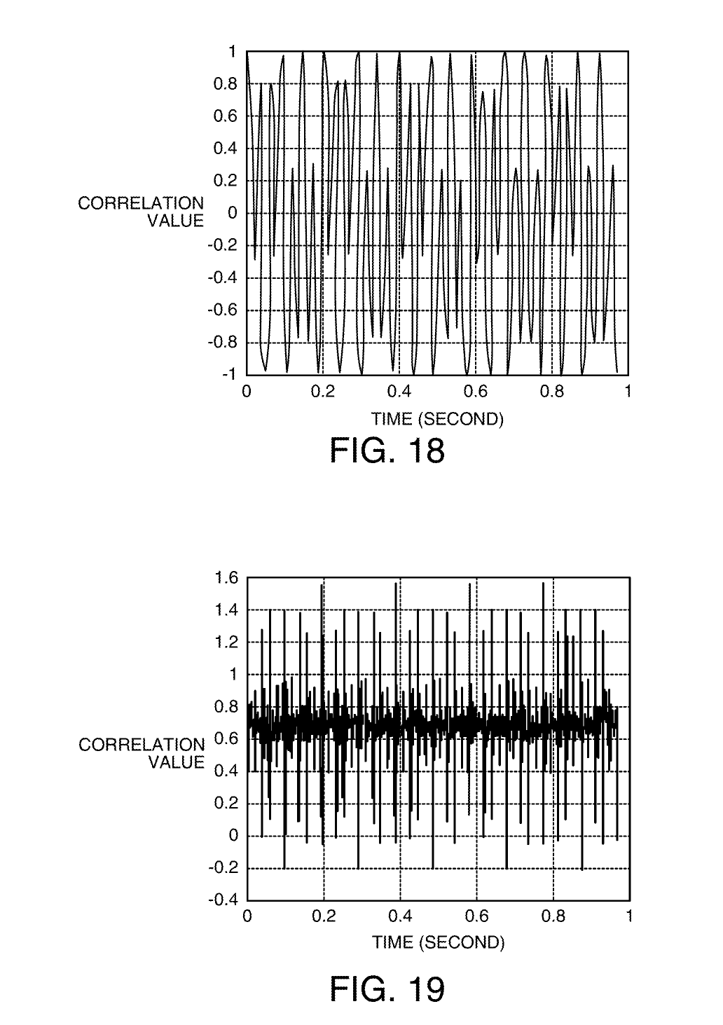

FIG. 18 is a graph illustrating the correlation values measured over 1000 milliseconds (1 second), which illustrates a time-series change in raw correlation values before performing the wavelet transform in the above-described fifth correlation process. The transverse axis represents time, and the longitudinal axis represents correlation values. Referring to this figure, it can be understood that the sign of the correlation value is changed in a short cycle as the polarity of the received CA code is inverted by the change in the bit value of the navigation message data and significantly vibrates over positive or negative areas around the correlation value “0”. The correlation values are integrated over the correlation integration time of 1000 milliseconds, and as a result, the integration correlation value becomes “0”.

FIG. 19 is a graph illustrating a time-series change in the correlation values obtained by reconfiguring the signal by performing the above-described fifth correlation process with respect to data on the correlation values in FIG. 18. Referring to this figure, it can be understood that the center of the correlation values is shifted in the positive area and the correlation values approximately converge to the positive value. Further, in consideration of the up and down vibration, in can be seen that a pulse shape change is partially recognized but the change is performed with small amplitude as a whole. The reconfigured correlation values are integrated over the correlation integration time of 1000 milliseconds, and as a result, the integration correlation value becomes a significantly large value “680”.

### (3) Other Correlation Processes

The fifth correlation process described with reference to FIG. 16 is an example of the correlation process using the wavelet transform, but the invention is not limited thereto. Examples of other correlation processes will be described with reference to flowcharts. In the following flowcharts to be described hereinafter, the same reference numerals are given to the same steps as the fifth correlation process, and thus, detailed description thereof will be omitted. Further, different steps from those in the fifth correlation process will be mainly described.

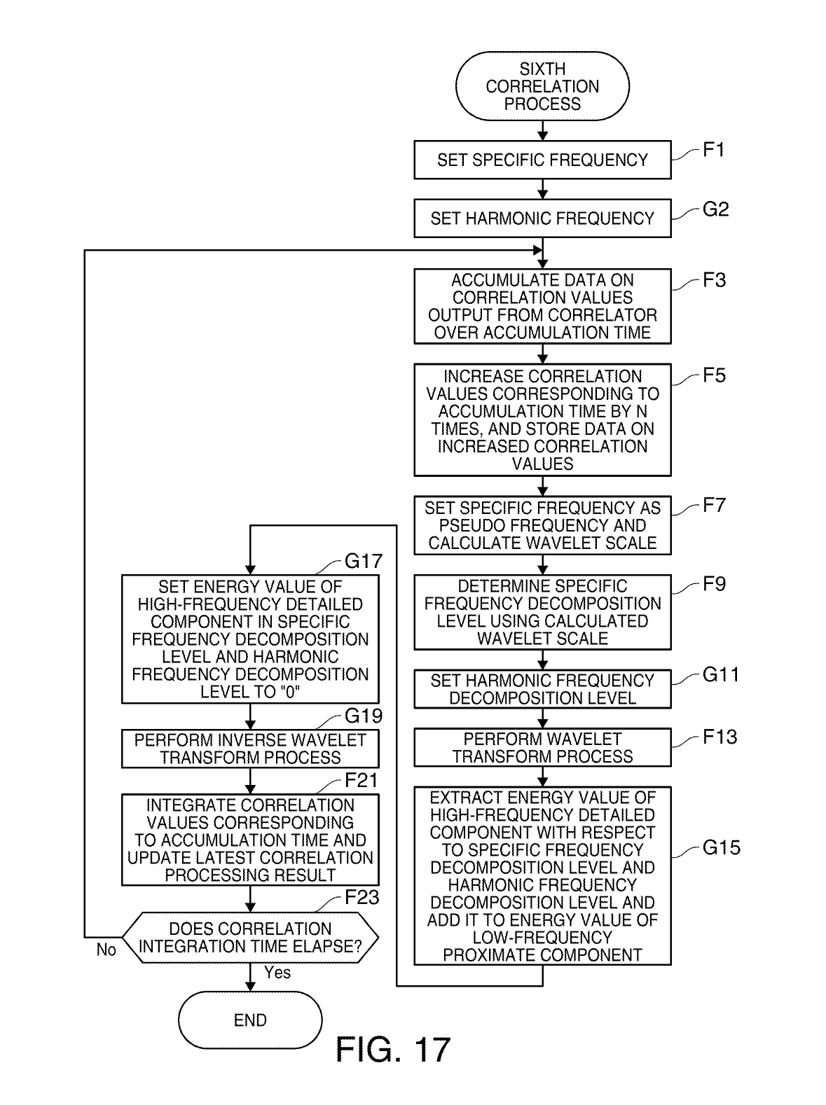

FIG. 17 is a flowchart illustrating a work flow of a sixth correlation process which is an example of other correlation processes. In the sixth correlation process, the satellite signal acquiring section 251 sets the specific frequency 278 instep F1, and then sets the harmonic frequency 279 (step G2). The harmonic frequency is set to the frequency of an odd multiple of the specific frequency.

The satellite signal acquiring section 251 determines the decomposition level (specific frequency decomposition level) “J” corresponding to the specific frequency (step F9) according to the formula (8), using the wavelet scale “a” calculated in step F7. Further, the satellite signal acquiring section 251 determines the decomposition level (hereinafter, referred to as a “harmonic frequency decomposition level”) corresponding to the harmonic frequency (step G11). That is, in a decomposition level lower than the specific frequency decomposition level “J”, the satellite signal acquiring section 251 specifies the decomposition level corresponding to the frequency of an odd multiple of the specific frequency and determines it as the harmonic frequency decomposition level.

After performing the wavelet transform process in step F13, the satellite signal acquiring section 251 extracts the energy value of the high-frequency detailed component with respect to the specific frequency decomposition level and the harmonic frequency decomposition level, and adds it to the energy value of the low-frequency proximate component (step G15). Further, the high-frequency detailed component in the specific frequency decomposition level and the harmonic frequency decomposition level is set to “0” (step G17). Then, the satellite signal acquiring section 251 transits the process to step F19.

In the sixth correlation process, since the reconfiguration of the correlation values is performed in consideration of the harmonic frequency component, in addition to the frequency component of the specific frequency, it is possible to accurately and rapidly acquire the GPS satellite signal.

In a similar way to the third correlation process described in the modification according to the first embodiment, the inverse wavelet transform is omitted, and thus, the energy value of the low-frequency proximate component in the specific frequency decomposition level may be considered as the correlation process result to acquire the GPS satellite signal.

### 3. Modifications

### 3-1. Electronic Devices

In the above-described embodiment, the invention is applied to a mobile phone which is a type of electronic device, but the electronic device to which the invention is able to be applied is not limited thereto. For example, the invention may be similarly applied to other electronic devices such as a car navigation device, a mobile navigation device, a personal computer, a PDA (Personal Digital Assistant) or a wrist watch.

### 3-2. Position Calculation System

Further, in the above-described embodiment, the GPS is exemplified as the position calculation system, but a position calculation system which uses other satellite positioning systems such as a WAAS (Wide Area Augmentation System), a QZSS (Quasi Zenith Satellite System), a GLONASS (GLObal Navigation Satellite System), a GALILEO, or the like may be employed.

### 3-3. Extraction of Power Value

In the above-described embodiment, a process of extracting the power value in the specific frequency and adding it to the power value in the zero frequency is performed. However, actually, the power value may appear as an error component in the frequency in the proximity to the specific frequency. Thus, it is preferable to perform the process in a state where a constant width is given to the specific frequency.

For example, using a range of ±1 Hz with reference to the specific frequency as a specific frequency range, all power values included in the specific frequency range are extracted, and the result is added to the power value in the zero frequency. Further, all the power values included in the specific frequency range are set to “0”. Further, after these processes are performed, the correlation values are reconfigured by performing the inverse frequency analysis.

The same process may be performed with respect to the harmonic frequency in addition to the specific frequency. That is, in a state where a constant width (for example, a harmonic frequency range of ±1 Hz with reference to the harmonic frequency) is given to the harmonic frequency, the power value included in the harmonic frequency range is extracted, and then the result is added to the power value in the zero frequency. Further, all power values included in the harmonic frequency range are set to “0”. Then, the inverse frequency analysis is performed.

### 3-4. Increased Correlation Values

In the above-described embodiment, the correlation values corresponding to the accumulation time are increased by n times to calculate the increased correlation values, and the frequency analysis is performed with respect to the time-series data on the increased correlation values. However, this process may be omitted and the frequency analysis may be performed with respect to the correlation value data corresponding to the accumulation time.

Further, without performing the frequency analysis for the increased correlation value data, the frequency analysis may be performed for data (intensification correlation value data) obtained by repeating the correlation values corresponding to the accumulation time over a predetermined intensification time. For example, as the intensification time, a time of a k multiple (k>1) of the accumulation time may be set. Then, the data obtained by repeating the correlation values corresponding to the accumulation time over the intensification time is generated as intensification correlation value data, and a power spectrum is obtained by performing the frequency analysis for the intensification correlation value data.

### 3-5. Frequency Analysis

Further, the frequency analysis is not limited to the Fourier transform or the wavelet transform. If the frequency component of the correlation values can be expressed as the power value, the same effect as in the above-described embodiment can be obtained by performing the correlation process based on other frequency analyses.

The entire disclosure of Japanese Patent Application No. 2010-037168, filed on Feb. 23, 2010 is expressly incorporated by reference herein.

What is claimed is:

1. A signal acquisition method comprising:
performing a correlation operation for a received satellite signal, the satellite signal being transmitted from a positioning satellite;
frequency-analyzing a result of the correlation operation over a predetermined time which is equal to or longer than a bit length of navigation message data carried by the satellite signal;
extracting a power value in a predetermined frequency which includes at least a specific frequency determined according to the bit length, from a result of the frequency analysis; and
acquiring the satellite signal using the extracted power value.

2. The signal acquisition method according to claim 1,
further comprising increasing the result of the correlation operation over the predetermined time by n times(n>1),
wherein the frequency analysis is performed for the result of the correlation operation which is increased by n times.

3. The signal acquisition method according to claim 1,
wherein the power value is extracted in the specific frequency and harmonics of the specific frequency, in the extraction.

4. The signal acquisition method according to claim 1,
wherein the acquisition is performed considering the extracted power value as a power value at a zero frequency, in the satellite signal acquisition.

5. The signal acquisition method according to claim 1,
wherein the satellite signal acquisition includes:
performing an inverse frequency analysis; and
acquiring the satellite signal using a result of the inverse frequency analysis.

6. The signal acquisition method according to claim 1,
wherein the frequency analysis uses a Fourier transform.

7. The signal acquisition method according to claim 1,
wherein the frequency analysis uses a wavelet transform.

8. A signal acquisition apparatus comprising:
a correlation operation section which performs a correlation operation for a satellite signal which is transmitted from a positioning satellite and received by a receiving section;
an analyzing section which frequency-analyzes a result of the correlation operation over a predetermined time which is equal to or longer than a bit length of navigation message data carried by the satellite signal;
an extracting section which extracts a power value in a predetermined frequency which includes at least a specific frequency determined according to the predetermined time, from a result of the frequency analysis; and
an acquiring section which acquires the satellite signal using the extracted power value.
